(19) United States
(12) Patent Application Publication
(10) Pub. No.: US 2026/0322707 A1
(43) Pub. Date: Oct. 15, 2026

(54) METHODS FOR ENABLING EFFICIENT SIGNALING OF NETWORK CONFIGURATION ASSISTANCE INFORMATION FOR BEAM MANAGEMENT

(71) Applicant: Telefonaktiebolaget LM Ericsson (publ), Stockholm (SE)

(72) Inventors: Jingya LI, GÖTEBORG (SE); Henrik RYDÉN, STOCKHOLM (SE); Yufei BLANKENSHIP, KILDEER, IL (US)

(73) Assignee: Telefonaktiebolaget LM Ericsson (publ), Stockholm (SE)

(21) Appl. No.: 19/485,889

(22) PCT Filed: May 20, 2024
(86) PCT No.: PCT/SE2024/050482

§ 371 Date: Nov. 19, 2025

Related U.S. Application Data
(60) Provisional application No. 63/467,816, filed on May 19, 2023.

(51) Int. Cl. H04L 41/16; H04B 7/06

(52) U.S. Cl. CPC H04L 41/16; H04B 7/0626

(57) ABSTRACT

A method performed by a user equipment operating in a mobile network is disclosed. The method includes obtaining system information associated with a plurality of cells of the mobile network, wherein the system information includes network configuration assistance information related to a network beam pattern configuration common to the plurality of cells; acquiring a new system information block, SIB, when connecting to a serving mobile network cell in the mobile network; and performing at least one machine learning, ML, process operation based on a comparison of the obtained system information and the acquired new SIB.

### TECHNICAL FIELD

The present disclosure relates generally to communications, and more particularly to methods and related mobile devices and mobile network nodes performing wireless and/or cellular based communications and signaling.

### BACKGROUND

As 3GPP Release 18 is being developed, there are ongoing discussions as to how a network can provide assistance information (e.g., beam pattern information) to a user equipment (UE) device. Such assistance information can largely depend on the granularity of the beam pattern that is signaled to the UE device. The frequency of such a transmission is typically associated to whenever the UE device enters a new cell. However, such a triggering event can impose a significant amount of signaling overhead for various beam prediction methods. Further, the UE device is unaware if other cells are using a similar beam pattern, which can cause uncertainty as to whether the UE device would ultimately benefit in training an AI/ML model for a certain beam pattern from the network. Because a particular UE vendor might not be served by a specific cell on a frequent basis, the overhead in collecting data and training a model for such a cell does not practically justify the overhead associated with the model training.

### SUMMARY

In one embodiment, the disclosed subject matter includes a method performed by a user equipment (UE) operating in a mobile network. The method comprises obtaining system information associated with a plurality of cells of the mobile network, wherein the system information includes network configuration assistance information related to a network beam pattern configuration common to the plurality of cells; acquiring a first system information block (SIB) when connecting to a serving mobile network cell in the mobile network; and performing at least one machine learning, ML, process operation based on a comparison of the obtained system information and the acquired first SIB. In some embodiments, this method may be embodied in a non-transitory computer readable medium that stores instructions executable by processing circuitry of a network node and/or a control system, wherein the instructions executed by the processing circuitry perform operations including the steps of the disclosed method.

In one embodiment, the disclosed subject matter includes a UE comprising processing circuitry and at least one memory storing instructions executable by the processing circuitry to perform operations to: obtain system information associated with a plurality of cells of the mobile network, wherein the system information includes network configuration assistance information related to a network beam pattern configuration common to the plurality of cells; acquire a new SIB when connecting to a serving mobile network cell in the mobile network; and perform at least one machine learning, ML, process operation based on a comparison of the obtained system information and the acquired new SIB.

In one embodiment, the disclosed subject matter includes a method performed by a network node. The method comprises identifying a plurality of cells in a mobile network that share a network beam pattern configuration; constructing system information associated with the plurality of cells, wherein the system information includes a first SIB associated with one or more of the plurality of cells and network configuration assistance information related to the network beam pattern configuration; broadcasting the system information to at least one UE. In some embodiments, this method may be embodied in a non-transitory computer readable medium that stores instructions executable by processing circuitry of a network node and/or a control system, wherein the instructions executed by the processing circuitry perform operations including the steps of the disclosed method.

In one embodiment, the disclosed subject matter includes a network node including processing circuitry and at least one memory storing instructions executable by the processing circuitry to perform operations to: identify a plurality of cells in a mobile network that share a network beam pattern configuration; construct system information associated with the plurality of cells, wherein the system information includes a first SIB associated with one or more of the plurality of cells and network configuration assistance information related to the network beam pattern configuration common to the plurality of cells; broadcast the system information to at least one UE.

Certain embodiments may provide one or more of the following technical advantage(s). The main advantages of the disclosed subject matter include: i) assistance information valid for multiple cells are transmitted in one broadcast message; this can reduce the signaling overhead since assistance information valid for multiple cells are transmitted and/or received in one message, ii) the UE can efficiently decide whether to train its models based on the received information, for example, only train for beam patterns that are valid over multiple cells and for a long time-duration; this would lead to more efficient data collection and training for UE-sided models, and iii) the beam pattern information can be readily available when a UE changes cell that is within the same area ID; hence this would allow faster usage of an AI/ML functionality.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram of training and inference pipelines and their respective interactions within a model lifecycle management procedure;

FIG. 2 illustrates a diagram depicting the use of an area identifier in an example deployment scenario according to some embodiments;

FIG. 3 is a diagram of example data collected on four different beams according to some embodiments;

FIG. 4 is a diagram of an example Pearson correlation matrix according to some embodiments;

FIG. 5 illustrates flow diagram of operations performed by a network node according to some embodiments;

FIG. 6 illustrates flow diagram of operations performed by a user equipment device according to some embodiments;

FIG. 7 illustrates flow diagram of operations performed by a network node according to some embodiments;

FIG. 8 illustrates flow diagram of operations performed by a user equipment device according to some embodiments;

FIG. 9 is a block diagram of a communication system in accordance with some embodiments;

FIG. 10 is a block diagram of a user equipment in accordance with some embodiments;

FIG. 11 is a block diagram of a network node in accordance with some embodiments;

FIG. 12 is a block diagram of a host in accordance with some embodiments; and

FIG. 13 is a block diagram of a virtualization environment in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

In both academia and industry, Artificial Intelligence (AI) and Machine Learning (ML) have been investigated as promising tools to optimize the design of air-interfaces used in wireless communication networks. In 3GPP standardization, the Release 18 study item explores the benefits of augmenting the air-interface with features enabling improved support of AI/ML-based algorithms for enhanced performance with reduced complexity and/or overhead.

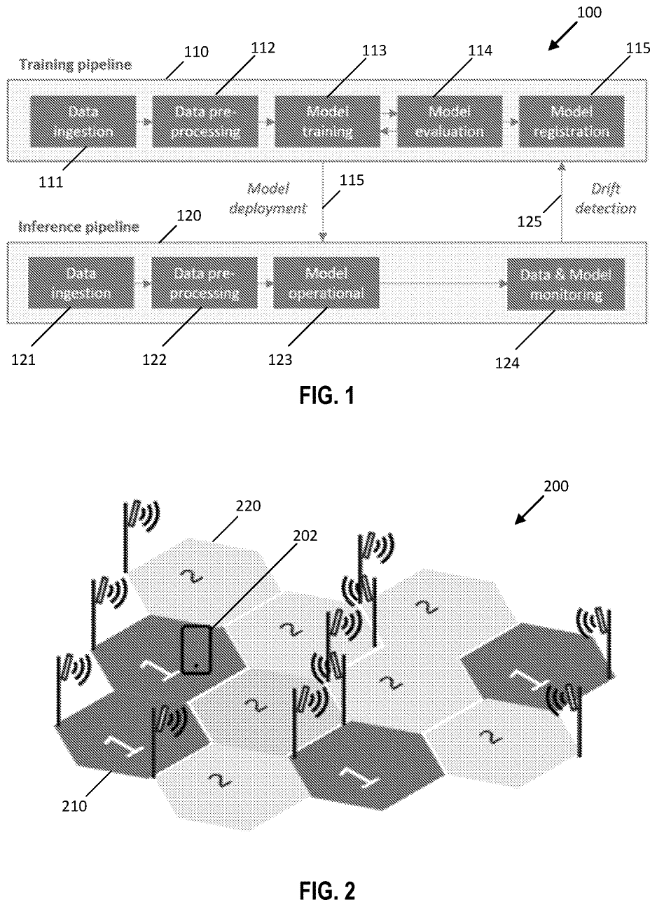

Building an AI/ML model includes several development stages where the actual training of the AI model is just one step in a training pipeline. An important part in AI/ML development is the AI/ML model lifecycle management. Diagram 100 of FIG. 1 illustrates a training pipeline 110 and inference pipeline 120 and their interactions within a model lifecycle management procedure. More specifically, the AI model lifecycle management typically includes i) a training (re-training) pipeline 110, ii) a deployment stage 115, iii) an inference pipeline 120, and iv) a drift detection stage 125.

The training (re-training) pipeline 110 includes a data ingestion stage 111 that involves the gathering of raw (training) data from a data storage. After ingestion of this data, the pipeline 110 may also proceed to a step/stage that controls the validity of the gathered data.

The training pipeline 110 further includes a data pre-processing stage 112 that refers to some feature engineering that is applied to the gathered data, e.g., it may involve data normalization and possibly data transformation that is required for the input data provided to the AI/ML model. After the data pre-processing stage 112, the training pipeline 110 is subjected to the actual AI model training steps (e.g., providing the model with a large amount of data and optimizing its parameters to learn patterns and make accurate predictions or decisions) in a model training stage 113. The training pipeline 110 also includes a model evaluation stage 114 that involves the benchmarking of the performance to some baseline. The iterative steps of model training and model evaluation continue until the acceptable level of performance (e.g., as previously exemplified) is achieved.

The training pipeline 110 further includes a model registration stage 115 that is responsible for the registration of the AI/ML model, including any corresponding AI/ML-metadata that provides information as to how the AI/ML model was developed, and possibly AI/ML model evaluations and performance outcomes.

The aforementioned deployment stage 115 can be configured to incorporate/integrate the trained (or re-trained) AI/ML model a part of the inference pipeline 120.

The inference pipeline 120 includes a data ingestion stage 121 where raw (inference) data is gathered from a data storage, and a data pre-processing stage 122 that is typically identical to the corresponding processing that occurs in the training pipeline 110. The inference pipeline 120 further includes a model operational stage 123 that involves using the trained and deployed model in an operational mode. The inference pipeline 120 also includes a data and model monitoring stage 124 that includes validation that the inference data is from a distribution that aligns well with the training data, as well as the monitoring of model outputs to detect any performance drifts and/or operational drifts. Notably, the AI model lifecycle management includes a drift detection stage 125 that informs and/or alerts about any drifts in the model operations.

One of the features of New Radio (NR) systems, as compared to previous generations of wireless networks, is the ability to operate in higher frequencies (e.g., above 10 GHz). The available large transmission bandwidths in these frequency ranges can potentially provide large data rates. However, as carrier frequency increases, both pathloss and penetration loss increase. To maintain the coverage at the same level, highly directional beams are required to focus the radio transmitter energy in a particular direction on the receiver. However, large radio antenna arrays—at both receiver and transmitter sides—are needed to create such highly directional beams.

To reduce hardware costs, large antenna arrays for high frequencies use time-domain analog beamforming. The core idea of analog beamforming is to share a single radio frequency chain between many (or, potentially, all) of the antenna elements. A limitation of analog beamforming is that it is only possible to transmit radio energy using one beam (in one direction) at a given time.

The above limitation requires the network (NW) and user equipment (UE) to perform beam management procedures to establish and maintain suitable transmitter (Tx)/receiver (Rx) beam-pairs. For example, beam management procedures can be used by a transmitter to sweep a geographic area by transmitting reference signals on different candidate beams, during non-overlapping time intervals, using a predetermined pattern. By measuring the quality of these reference signals at the receiver side, the best transmit and receive beams can be identified.

Beam management procedures in NR is defined by a set of L1/L2 procedures that establish and maintain suitable beam pairs for both the transmitting data and receiving data. A beam management procedure can include the following sub procedures: beam determination, beam measurements, beam reporting, and beam sweeping.

For beam management, a UE can be configured to report Reference Signal Receive Power (RSRP) or/and signal-to-interference-plus-noise ratio (SINR) for each one of up to four beams, either on a Channel State Information Reference Signal (CSI-RS) or Synchronization Signal Block (SSB). UE measurement reports can be sent either over Physical Uplink Control Channel (PUCCH) or Physical Uplink Shared Channel (PUSCH) to the network node, e.g., gNB.

A CSI-RS is transmitted over each transmit (Tx) antenna port at the network node and for different antenna ports. The CSI-RS are multiplexed in time, frequency, and code domain such that the channel between each Tx antenna port at the network node and each receive antenna port at a UE can be measured by the UE. A time frequency resource used for transmitting CSI-RS is referred to as a CSI-RS resource.

In NR, the CSI-RS for beam management is defined as a 1-port or 2-port CSI-RS resource in a CSI-RS resource set where the filed repetition is present. The following three types of CSI-RS transmissions are supported.

Periodic CSI-RS: CSI-RS is transmitted periodically in certain slots. This CSI-RS transmission is semi-statically configured using RRC signaling with parameters such as CSI-RS resource, periodicity, and slot offset.

Semi-Persistent CSI-RS: Similar to periodic CSI-RS, resources for semi-persistent CSI-RS transmissions are semi-statically configured using radio resource control (RRC) signaling with parameters such as periodicity and slot offset. However, unlike periodic CSI-RS, dynamic signaling is needed to activate and deactivate the CSI-RS transmission.

Aperiodic CSI-RS: This is a one-shot CSI-RS transmission that can happen in any slot. Here, one-shot means that CSI-RS transmission only happens once per trigger. The CSI-RS resources (i.e., the RE locations which consist of subcarrier locations and OFDM symbol locations) for aperiodic CSI-RS are semi-statically configured. The transmission of aperiodic CSI-RS is triggered by dynamic signaling through PDCCH using the CSI request field in uplink (UL) Downlink Control Information (DCI), in the same DCI where the UL resources for the measurement report are scheduled. Multiple aperiodic CSI-RS resources can be included in a CSI-RS resource set and the triggering of aperiodic CSI-RS is on a resource set basis.

In NR, an SSB consists of a pair of synchronization signals (SSs), physical broadcast channel (PBCH), and Demodulation reference signals (DMRS) for PBCH. A SSB is mapped to 4 consecutive Orthogonal Frequency Division Multiplexing (OFDM) symbols in the time domain and 240 contiguous subcarriers (20 RBs) in the frequency domain.

To support beamforming and beam-sweeping for SSB transmission, in NR, a cell can transmit multiple SSBs in different narrow-beams in a time multiplexed fashion. The transmission of these SSBs is confined to a half frame time interval (e.g., 5 milliseconds). It is also possible to configure a cell to transmit multiple SSBs in a single wide beam with multiple repetitions. The design of beamforming parameters for each of the SSBs within a half frame is up to network implementation. The SSBs within a half frame are broadcast periodically from each cell. The periodicity of the half frames with SS/PBCH blocks is referred to as SSB periodicity, which is indicated by a System Information Block Type 1 (SIB1).

The maximum number of SSBs within a half frame, denoted by L, depends on the frequency band, and the time locations for these L candidate SSBs within a half frame depends on the subcarrier spacing (SCS) of the SSBs. The L candidate SSBs within a half frame are indexed in an ascending order in time from 0 to L−1. By successfully detecting PBCH and its associated DMRS, a UE knows the SSB index. A cell does not necessarily transmit SS/PBCH blocks in all L candidate locations in a half frame, and the resource of the un-used candidate positions can be used for the transmission of data or control signaling instead. It is up to network implementation to decide which candidate time locations to select for SSB transmission within a half frame, and which beam to use for each SSB transmission.

In some embodiments, the present subject matter discloses a method where a network node (e.g., gNB) signals its network configuration assistance information (e.g., network beam pattern configuration) to a UE(s) via a new SIB referred to herein as a ‘networkAssistanceDataSIB’. In some embodiments, Notably, the networkAssistanceDataSIB may be generally referred to as a ‘network configuration assistance information SIB’, or any other SIB that can be configured to contain the network configuration assistance information as described herein. Further, the present disclosure may also utilize an SI message acquisition IE (e.g., SI-schedulingInfo IE contained in SIB1) together with the networkAssistanceDataSIB to provide its network configuration assistance information. In some embodiments, the SI-schedulingInfo IE in the SIB informs the UE about the scheduling of other SIBs, such as informing the UE about the new networkAssistanceDataSIB (i.e., system information). Notably, the networkAssistanceDataSIB contains network beam pattern configuration information.

In particular, the networkAssistanceDataSIB carries and/or contains the network configuration assistance data. Examples of network configuration assistance data include i) network beam pattern configuration data including network antenna/beam pattern related information (e.g., a network antenna configuration identification parameter, a set of antenna/beam pattern configuration parameters, etc.) and ii) the time duration where part of or all the network configuration assistance data is valid (e.g., an expirationTime parameter).

In some embodiments, the system information (SI) message acquisition IE carries at least one of the following information (e.g., ‘network assistance related information’) related to the networkAssistanceDataSIB: i) whether the networkAssistanceDataSIB is cell specific or area specific (indicated by, e.g., an areaScope parameter); ii) if the networkAssistanceDataSIB is area specific, then, the system information area the networkAssistanceDataSIB belongs to (e.g., indicated by a SystemInformationAreaID parameter), iii) the version of the network configuration assistance data carried in the networkAssistanceDataSIB (e.g., indicated by a valueTag parameter), iv) the time duration where the content carried in the networkAssistanceDataSIB is valid (e.g., by an expirationTime parameter).

During the system information acquisition procedure, a UE acquires a first SIB (e.g., SIB1) and networkAssistanceDataSIB of the cell. The UE stores the received networkAssistanceDataSIB together with the information related to this first SIB (e.g., areaScope, SystemInformationAreaID, valueTag, expirationTime, and the first PLMN-Identity/NPN-Identity). A UE may store multiple versions of networkAssistanceDataSIBs together with their associated information.

When the UE enters a new cell or reconnects to the same cell, it acquires a SIB (e.g., a new SIB, or new SIB1) from the current serving mobile network cell, and obtains the associated information about the networkAssistanceDataSIB of the serving mobile network cell. The UE compares the associated information (e.g., network assistance related information) of each stored version of networkAssistanceDataSIB (e.g., areaScope, SystemInformationAreaID, valueTag, expirationTime, the first PLMN-Identity/NPN-Identity) to the information received from the new SIB (e.g., SIB1) from the current serving mobile network cell. Based on the comparison results, the UE can take AI/ML model life cycle management (LCM) operations accordingly. For instance, if the information matches a stored networkAssistanceDataSIB, then the UE considers the stored networkAssistanceDataSIB to be valid for the serving mobile network cell. The UE can then select the AI/ML model trained for the corresponding network configuration. However, if none of the stored networkAssistanceDataSIBs match to the information acquired from the new SIB (e.g., SIB1) of the serving mobile network cell, then the UE can trigger a model fallback, request new data collection for the current network configuration scenario, and/or acquire the networkAssistanceDataSIB of the current serving mobile network cell.

In some embodiments, the disclosed subject matter includes a method to broadcast network assistance information for beam prediction using an SI message acquisition IE (e.g., SI-schedulingInfo IE contained in SIB1) together with a newly defined SIB (i.e., networkAssistanceDataSIB), which can indicate that the network assistance information (e.g., comprising beam patterns) that is valid for multiple cells. As such, the disclosed subject matter avoids frequent downlink signaling or UE processing for receiving such information.

### Network Assistance Information in a New System Information

In some embodiments, the network assistance information for the UE-side AI/ML model (beam management) is provided via broadcast information in a new system information, similar to positioning system information. As an example, the signaling can be provided as follows:

| | |
|---|---|
| SystemInformation ::= | SEQUENCE { |
| criticalExtensions | CHOICE { |
| systemInformation | SystemInformation-IEs, |
| criticalExtensionsFuture-r16 | CHOICE { |
| posSystemInformation-r16 | PosSystemInformation-r16-IEs, |
| criticalExtensionsFuture-r18 | CHOICE { |
| aimlSystemInformation | AIMLSystemInformation-IEs, |
| criticalExtensionsFuture | SEQUENCE { } |

```
      }
    }
  }
}
AIMLSystemInformation-IEs ::= SEQUENCE {
```

| aimlSIB-TypeAndInfo | SEQUENCE { | |
|---|---|---|
| aimlSib1 | SIB-AIML-CSI | OPTIONAL, |
| aimlSib2 | SIB-AIML-BM | OPTIONAL, |

},

| | | |
|---|---|---|
| lateNonCriticalExtension | OCTET STRING | OPTIONAL, |
| nonCriticalExtension | SEQUENCE { } | OPTIONAL |

}
SIB-AIML-BM ::= SEQUENCE {

| | | |
|---|---|---|
| valueTag | INTEGER (0..63) | OPTIONAL, -- Need OP |
| areaScope | ENUMERATED {true} | OPTIONAL, -- Need OP |
| expirationTime | UTCTime | OPTIONAL, -- Need OP |

| | |
|---|---|
| assistanceDataElementAIMLBM | SEQUENCE { |
| csi-SSB-ResourceList | SEQUENCE (SIZE(1..maxNrofCSI-SSB-ResourcePerSet)) OF |

SSBInfo,

| | |
|---|---|
| candidateBeamRS-List-r16 | SEQUENCE (SIZE(1..maxNrofCandidateBeams)) OF |

```
CandidateBeamRS OPTIONAL,
  ...
}
SSBInfo ::= SEQUENCE {
  ssb-Index SSB-Index,
```

| | | |
|---|---|---|
| nr-SSB-BeamAntennaAngles | NR-SSB-BeamAntennaAngles | OPTIONAL, -- Need OP |

NR-TRP-BeamAntennaAngles-r17 ::= SEQUENCE (SIZE(1..3600)) OF

NR-TRP-BeamAntennaInfoAzimuthElevation-r17

NR-TRP-BeamAntennaInfoAzimuthElevation-r17 ::= SEQUENCE {

| | | |
|---|---|---|
| azimuth-r17 | INTEGER (0..359) | OPTIONAL, -- Cond Az |
| azimuth-fine-r17 | INTEGER (0..9) | OPTIONAL, -- Cond |

AzOpt

| | |
|---|---|
| elevationList-r17 | SEQUENCE (SIZE(1..1801)) OF ElevationElement-R17, |

...
}
ElevationElement-R17 ::= SEQUENCE {

| | | |
|---|---|---|
| elevation-r17 | INTEGER (0..180) | OPTIONAL, -- Cond El |
| elevation-fine-r17 | INTEGER (0..9) | OPTIONAL, -- Cond |

ElOpt

| | |
|---|---|
| beamPowerList-r17 | SEQUENCE (SIZE (2..maxNumResourcesPerAngle-r17)) OF |
| | BeamPowerElement-r17, |

...
}
BeamPowerElement-r17 ::= SEQUENCE {

| nr-dl-prs-ResourceSetID-r17 | NR-DL-PRS-ResourceSetID-r16 | OPTIONAL, -- Need OP |
|---|---|---|
| nr-dl-prs-ResourceID-r17 | NR-DL-PRS-ResourceID-r16, | |
| nr-dl-prs-RelativePower-r17 | INTEGER (0..30), | |
| nr-dl-prs-RelativePowerFine-r17 | INTEGER (0..9) | OPTIONAL, -- Need ON |

...
}

In some embodiments, the scheduling information of the network assistance information for AI/ML can be defined as well as follows:

| | |
|---|---|
| AIMLSI-SchedulingInfo ::= | SEQUENCE { |
| AIMLSchedulingInfoList | SEQUENCE (SIZE (1..maxSI-Message)) OF |

AIMLSchedulingInfo,

| | |
|---|---|
| AIMLSI-RequestConfig | SI-RequestConfig |

OPTIONAL, -- Cond MSG-1

| | |
|---|---|
| AIMLSI-RequestConfigSUL | SI-RequestConfig |

OPTIONAL, -- Cond SUL-MSG-1
...,
}

Using the UE-sided AI/ML based beam prediction as an example, the disclosed method can enable the network (e.g., a network node, base station, gNB, etc.) to signal a beam pattern that might be valid for several cells in a mobile network in one SIB transmission. It would also enable UEs to decide whether to collect data and train a ML model for such a beam pattern based on how frequent (e.g., the number of cells in each areaID) the beam pattern is utilized. In some embodiments, example steps of the present subject matter from a network perspective is as follows. Notably, the order among steps 100-103 can be changed.

In step 100: identify cells sharing the same beam pattern, and setting the SystemInformationAreaID parameter in the SIB1 (e.g., a first SIB).

In step 101: configure the beam pattern assistance information in the networkAssistanceDataSIB message.

In step 102: Set the valueTag for the networkAssistanceDataSIB message in the SIB1 to be the version of the beam pattern configuration.

In step 103: Set the areaScope for the networkAssistanceDataSIB message to be ‘True’ in the SIB1.

In step 104: Broadcast the SIB1 and networkAssistanceDataSIB.

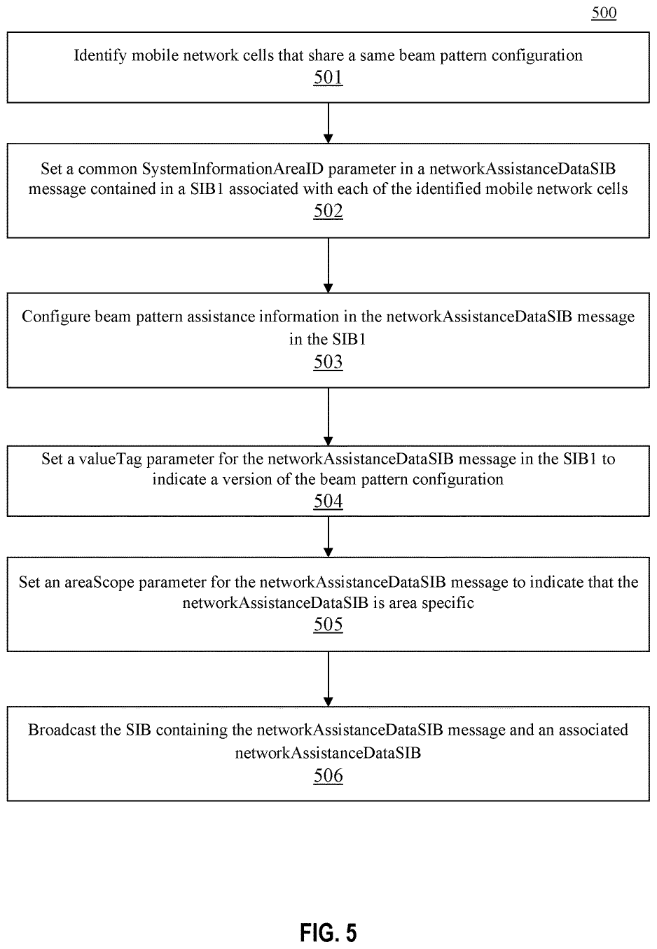

To further illustrate, FIG. 5 is a flow chart of a method and/or process 500 executed by one or more network nodes (e.g., a gNB or the like). In some embodiments, process 500 may be a software algorithm that is stored in memory and executed by one or more processors (and/or processing circuitry) of the one or more network nodes (or a computer system hosting the network node(s)). For example, process 500 may be stored in memory 1104 and executed by processing circuitry 1102 in FIG. 11 as described below. In some embodiments, process 500 may be executed to broadcast network assistance information for beam prediction together with a newly defined SIB, i.e., a networkAssistanceDataSIB, or some other network configuration assistance information SIB.

In block 501, process 500 includes identifying mobile network cells that share the same beam pattern configuration. In some embodiments, a network node (e.g., a gNB) in a mobile network is configured to identify the mobile network cells that share the same beam pattern. For example, the cells that are analyzed and/or identified by the network node may all be positioned in a defined and/or related area.

In block 502, process 500 includes setting a common SystemInformationAreaID parameter in a networkAssistanceDataSIB message contained in a system information block 1, SIB1, associated with each of the identified mobile network cells. In some embodiments, the network node is configured to set the SystemInformationAreaID parameter (or any other like parameter) in an SI message acquisition IE, which is contained in the SIB1 (or each of the SIB1s) associated with each of the identified mobile network cells.

In block 503, process 500 includes configuring beam pattern assistance information in the networkAssistanceDataSIB message. In some embodiments, the network node may configure the beam pattern assistance information contained in the network configuration assistance information.

In block 504, process 500 includes setting a valueTag parameter for the networkAssistanceDataSIB message in the SIB1 to indicate a version of the beam pattern configuration. In some embodiments, the network node may set the valueTag parameter (or like parameter) in the SI message acquisition IE contained in the SIB1. The valueTag parameter may be used to indicate the version of the network configuration assistance data carried in the networkAssistanceDataSIB.

In block 505, process 500 includes setting an areaScope parameter for the networkAssistanceDataSIB message to indicate that the networkAssistanceDataSIB is area specific. In some embodiments, the network node may set the areaScope parameter (or any other like parameter) in the SI message acquisition IE contained in the SIB1. The areaScope parameter can be used to indicate whether the networkAssistanceDataSIB is cell specific or area specific.

In block 506, process 500 includes broadcasting the SIB1 and an associated networkAssistanceDataSIB. In some embodiments, the network node ultimately completes the provisioning of the network configuration assistance information in the networkAssistanceDataSIB message, and/or SI message acquisition IE that is contained in the SIB1 and is configured to broadcast both the SIB1 (containing the network assistance related information that is associated with and/or related to the networkAssistanceDataSIB) and the networkAssistanceDataSIB to one or more UEs.

An example of the disclosed subject matter executed from a UE perspective is as follows in steps 200-203. In step 200, the UE acquires a SIB1 and a networkAssistanceDataSIB from a cell (e.g., a network node, gNB, etc.) and stores the networkAssistanceDataSIB together with the associated information (e.g., network assistance related information), which includes SystemInformationAreaID, valueTag for the networkAssistanceDataSIB, areaScope for the networkAssistanceDataSIB, and the like. In some embodiments, a UE may perform this step multiple times in the same cell, or/and perform this steps multiple times for different cells, hence, the UE may store multiple networkAssistanceDataSIBs.

In step 201, the UE enters a new cell or reconnects to the same cell. In step 202, the UE acquires SIB1 from the serving mobile network cell (i.e., serving cell). In step 203, the UE compares the associated information for each stored networkAssistanceDataSIB (e.g., SystemInformationAreaID, valueTag for the networkAssistanceDataSIB, and areaScope for the networkAssistanceDataSIB) with the information received from SIB1 (i.e., a new SIB1 signaled by the serving mobile network cell). If the information matches data for a stored networkAssistanceDataSIB, the UE considers the stored networkAssistanceDataSIB as valid for the serving cell. An optional UE action may be that the UE selects the AI/ML model trained for the beam pattern configuration indicated by the valid networkAssistanceDataSIB. If none of the stored networkAssistanceDataSIBs match to the information acquired from SIB1, then no stored networkAssistanceDataSIB is valid. Optional UE actions may include that the UE request fallback to a non-ML beam prediction algorithm, or/and the UE acquires a networkAssistanceDataSIB from the serving cell, or/and the UE requests data collection for the current beam pattern configuration in the serving cell.

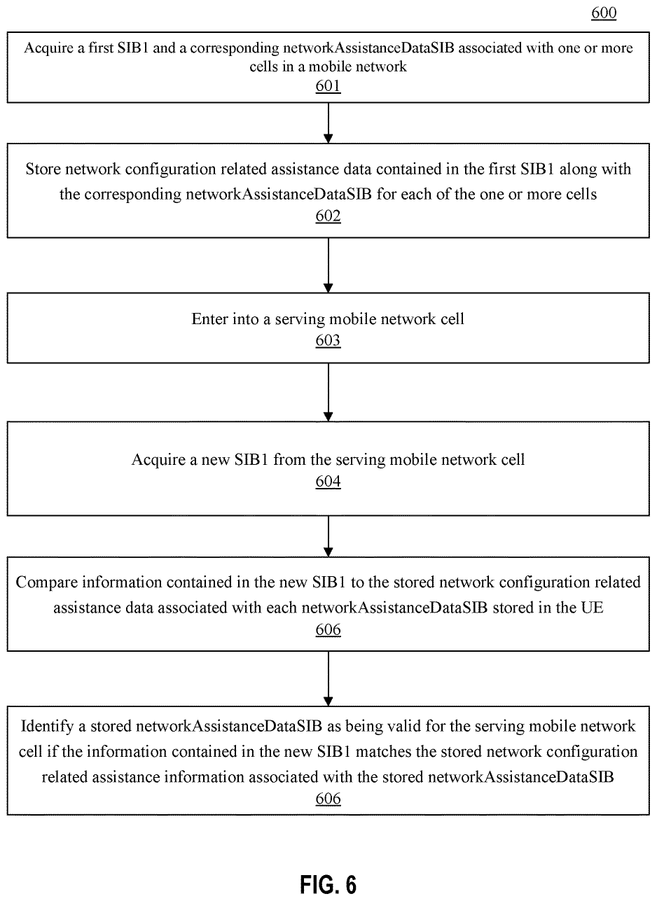

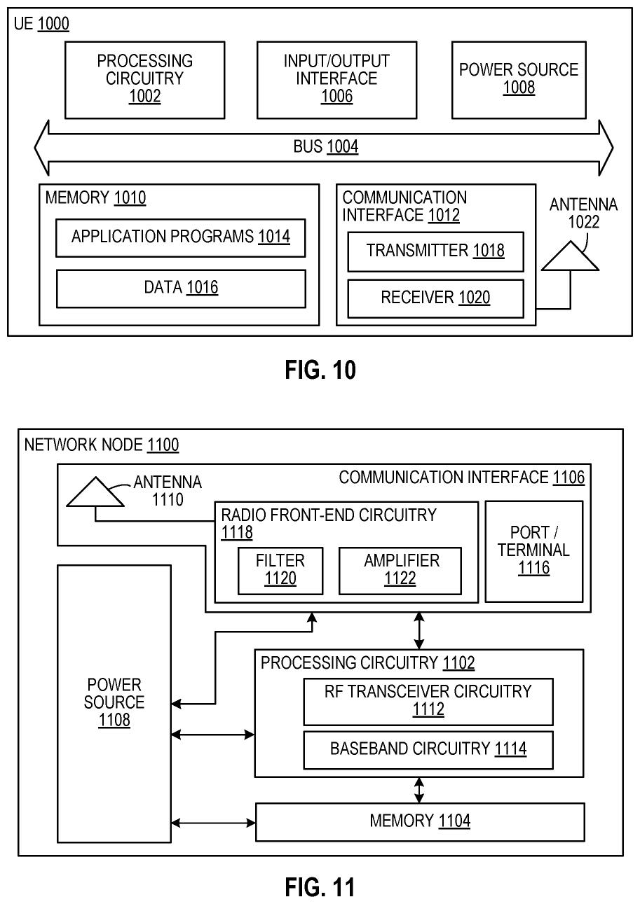

FIG. 6 is a flow chart of a method and/or process 600 executed by one or more UEs (e.g., a smartphone, tablet, laptop computer, or any other computing device that can utilize a wireless/cellular data connection). In some embodiments, process 600 may represent a software algorithm that is stored in memory and executed by one or more processors (and/or processing circuitry) of a UE. For example, process 600 may be stored in memory 1010 and executed by processing circuitry 1002 in FIG. 10 as described below. In some embodiments, process 600 may be executed to determine if a stored networkAssistanceDataSIB is valid and/or applicable to a serving mobile network cell. Upon determining the validity of a stored networkAssistanceDataSIB, a UE may then select an appropriate AI/ML model trained for a beam pattern configuration indicated by the valid networkAssistanceDataSIB.

In block 601, process 600 includes acquiring a first SIB1 (e.g., a first SIB) and a corresponding networkAssistanceDataSIB associated with one or more cells in a mobile network. In some embodiments, a UE is configured to obtain an SIB1 and a networkAssistanceDataSIB associated with one or more cells in a mobile network. In other embodiments, the UE may be provisioned or provided with the SIB1 and networkAssistanceDataSIB for a plurality of cells in the mobile network. Although FIG. 6 indicates the use of an SIB1, any type of SIB can be used without departing from the scope of the disclosed subject matter. More specifically, as used herein, the term “SIB” may refer to any type of session information block, such as a Type 1 SIB (i.e., SIB1), Type 2 SIB (i.e., SIB2), and/or the like.

In block 602, process 600 includes storing network configuration related assistance data (i.e., network assistance related information) contained in the first SIB1 along with the corresponding networkAssistanceDataSIB for each of the one or more cells. After receiving the SIB1 and networkAssistanceDataSIB, the UE stores the networkAssistanceDataSIB along with the associated network assistance related information (as previously indicated in the SI message acquisition IE of the related SIB1).

In block 603, process 600 includes entering into a serving mobile network cell. In some embodiments, the UE is roaming and either moves into a new mobile network cell or reconnects with the same cell the UE was located in.

In block 604, process 600 includes acquiring a new SIB1 from the serving mobile network cell. In some embodiments, the UE acquires the SIB1 associated with the mobile network cell the UE just entered or the cell the UE is attempting to reconnect to.

In block 605, process 600 includes comparing information contained in the new SIB1 to the stored network configuration related assistance data associated with each networkAssistanceDataSIB stored in the UE. In some embodiments, the UE is configured to compare i) the network configuration related assistance data (i.e., previously carried in the SI message acquisition IE of the related SIB1) corresponding to each of the networkAssistanceDataSIBs stored in the UE to ii) the newly acquired information received from the SIB1.

In block 606, process 600 includes identifying a stored networkAssistanceDataSIB as being valid for the serving mobile network cell if the information contained in the new SIB1 matches the stored network configuration related assistance information (e.g., system information and/or network assistance related information) associated with the stored networkAssistanceDataSIB. In some embodiments, the comparison conducted in block 605 yields a match between the newly acquired information received from the SIB1 and the at least one network configuration related assistance data associated with networkAssistanceDataSIB stored on the UE. Upon identifying a match, the UE determines and/or considers the stored networkAssistanceDataSIB as being valid for the serving cell. In some embodiments, the UE is configured to select and/or utilize an AI/ML model trained for the beam pattern configuration indicated by the valid networkAssistanceDataSIB.

In the event a match is not found from the comparison conducted in block 605, then the UE will not recognize any of the stored networkAssistanceDataSIBs as being valid for the serving cell. In some embodiments, the UE may be configured to perform one or more optional UE actions (e.g., “remedial actions”) that may include, but are not limited to, requesting a fallback to a non-ML beam prediction algorithm, acquire a networkAssistanceDataSIB from the serving cell, and/or request data collection for the current beam pattern configuration in the serving cell.

### Assistance Information in a New System Information Block (SIB)

In some embodiments, the assistance information for UE-side AI/ML model (beam management) is provided via a new SIB, e.g., SIB22. In this case, SIB22 is introduced which contains the assistance information for supporting AI/ML functionalities.

SIB22-r18 ::= SEQUENCE {

| | |
|---|---|
| csi-SSB-ResourceList | SEQUENCE (SIZE(1..maxNrofCSI-SSB-ResourcePerSet)) OF |

SSBInfo,

| | |
|---|---|
| candidateBeamRS-List-r16 | SEQUENCE (SIZE(1..maxNrofCandidateBeams)) OF |

CandidateBeamRS OPTIONAL,

| | |
|---|---|
| lateNonCriticalExtension | OCTET STRING OPTIONAL, |

```
  ...
}
SSBInfo ::= SEQUENCE {
  ssb-Index SSB-Index,
```

| | |
|---|---|
| nr-SSB-BeamAntennaAngles | NR-SSB-BeamAntennaAngles OPTIONAL, -- Need OP |

### Assistance Information in CSI-RS Resource Configuration

In some embodiments, the beam pattern tag and beam pattern area can be signaled in a CSI-RS resource configuration for the AI/ML based beam management. For example, the beam pattern tag may be used to indicate to the UE any change in the downlink (DL) beam pattern. The beam pattern tag is incremented by one by the gNB (or network node), every time the DL beam pattern used for Set A and Set B is changed. Further, the beam pattern area ID indicates the beam pattern area that the cell belongs to. For every cell in a given beam pattern area, the same DL beam pattern is used. Notably, the beam pattern area ID is unique within a PLMN/SNPN.

| | |
|---|---|
| CSI-AIML-BM-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

nzp-CSI-RS-ResourceSetList SEQUENCE (SIZE (1..maxNrofNZP-CSI-RS-
ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM-ResourceSetsPerConfig)) |

OF CSI-IM-ResourceSetId
},

| | |
|---|---|
| bwp-Id | BWP-Id, |
| resourceType | ENUMERATED { aperiodic, semiPersistent, periodic }, |
| beamPatternAreaID | BIT STRING (SIZE (24)) OPTIONAL, |
| beamPatternTag | INTEGER (0..31) OPTIONAL, |

...,
}

Assistance information for an example beam management use case is disclosed herein. In such an example, “gNB TX beam assistance information” can, for instance, include one or more of: Spatial correlation between different gNB Tx beams, QCL association between different gNB TX beams, azimuth and elevation pointing angle of different gNB TX beams, beamwidth for different gNB TX beams, TX-beam IDs, the number of horizontal/vertical TX beams, the number of antenna elements, the beamforming gain for each gNB TX beam, and/or information of Set A and Set B beams.

The following may be associated to the beam pattern information: i) value Tag: For system information, valueTag gives the SI version info. For beam pattern that can be updated by gNB, valueTag can keep track of the beam pattern version, and ii) expirationTime: This can be used by gNB to indicate how long the beam pattern is.

In some embodiments, the disclosed subject matter includes a UE-side model for DL Tx beam prediction. For the UE-side model, the same AI/ML model and associated network assistance information (e.g. beam pattern information listed above) can be used as long as the UE stays within the SI area, and the UE can move from one cell to another cell. The steps for model inference are outlined as follows: 1) the gNB sweeps over beams in Set B, which are the SSB beams. In one deployment, the same SSB beams are used among all the cells in a SI area. In addition, the gNB indicates to the UE that the same SSB beams are used as Set B across cells in the same area. The indication is provided by the information provided in SI-SchedulingInfo (including systemInformationAreaID) as well as Set B resource configuration; 2) UE measures the SSB wide beams in Set B; 3) the Set B measurement is used as AI/ML model input to generate the Top-K predicted DL Tx beams within Set A; and 4) the UE reports the predicted Top-K DL Tx beams to the gNB.

The disclosed subject matter provides for a number of UE-implementation details. For example, the UE can decide to collect data and train a ML model in case of i) at least N cells share the same beam pattern, indicated in the SIB message and/or ii) at least M of the N cells are visited by the UE over the last time period. After the UE has trained a ML model, the UE can include in the UE capability indication for which areaID the model is trained for.

The disclosed subject matter provides for a number of network-implementation details. For example, in further embodiments, based on the SI area ID, the network (e.g., network node) can perform network decisions such as performing handovers of UEs to a target cell associated with the same area ID as the serving cell. This would enable the UE to continue using the same model/functionality in the target cell. Note that the UE can be within coverage of multiple carrier frequencies, and the network can have flexibility in selecting which cell that UE should be handed over to. As an example, FIG. 2 illustrates the use of an area identifier (ID) as an example deployment scenario. FIG. 2 depicts a UE 202 located in a mobile network 200 comprising a plurality of cells. Notably, the plurality of cells are separated into two groups of cells, i.e., cells with an area ID equal to 1 (e.g., cell 210) and cells with and area ID equal to 2 (e.g., cell 220). In one example of FIG. 2, the network configuration assistance information received by UE 202 is valid for all ‘areaID=1’ cells.

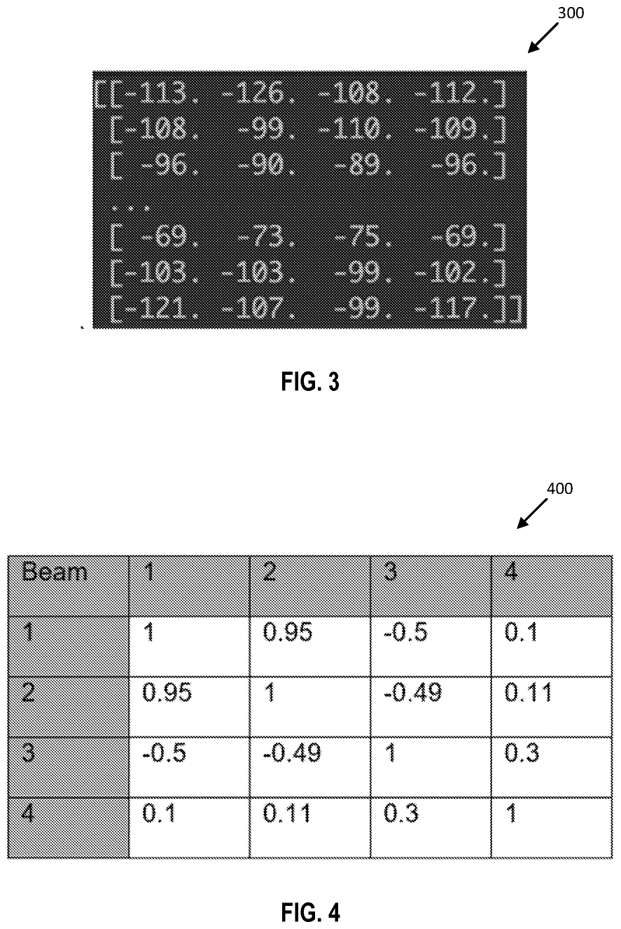

Examples of spatial correlation part of assistance information are also described herein. In one example, the network (e.g., network node) first collects a set of measurements comprising RSRP data for the gNB transmitted 4 SSB-beams. One example is shown in diagram 300 of FIG. 3, which depicts example data collected on four different beams.

Next, the network calculates the correlation among the different beams and generates a Pearson coefficient matrix for each pair. The matrix 400 depicted in FIG. 4 shows how beam 1 and beam 2 are highly correlated. This correlation could for example be used by the UEs to build a beam predictor for the second beam using beam 1 measurements. The network would in this example include matrix 400 (e.g., a Pearson correlation matrix) shown in FIG. 4 in the assistance information element.

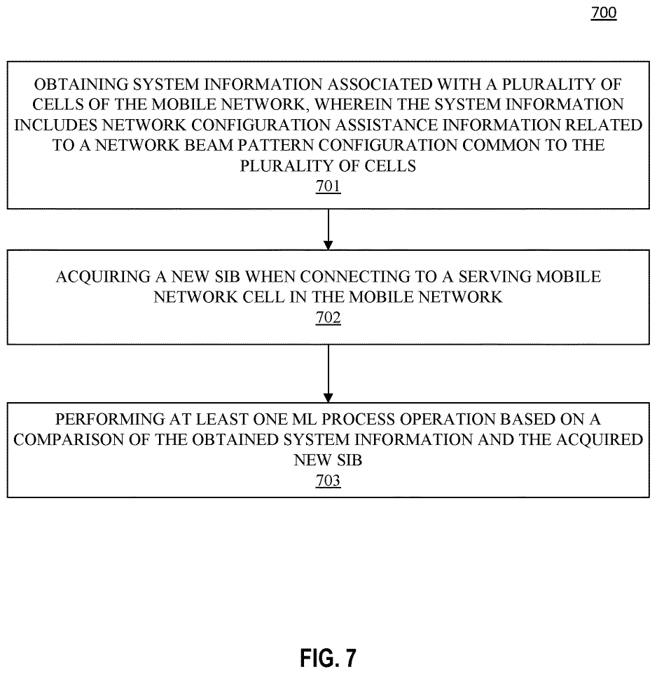

FIG. 7 illustrates a flowchart 700 of a method depicting exemplary operations for enable efficient signaling of network configuration assistance information according to one embodiment. Operations of the user equipment (UE), which may be implemented using the structure of the block diagram of FIG. 10, will now be discussed with reference to the flowchart 700 according to some embodiments. For example, one or more modules (e.g., software based algorithms or programming code) may be stored in memory 1010 of FIG. 10, and these modules may provide instructions so that when the instructions of a module are executed by respective processing circuitry 1002, the UE 1000 performs respective operations of the flowchart 700.

In block 701, the method 700 includes obtaining system information associated with a plurality of cells of the mobile network, wherein the system information includes network configuration assistance information related to a network beam pattern configuration common to the plurality of cells.

In block 702, the method 700 includes acquiring a new SIB when connecting to a serving mobile network cell in the mobile network. As indicated above, the term “SIB” may refer to any type of session information block, such as a Type 1 SIB (i.e., SIB1), Type 2 SIB (i.e., SIB2), and/or the like without departing from the scope of the disclosed subject matter.

In block 703, the method 700 includes performing at least one ML process operation based on a comparison of the obtained system information and the acquired new SIB.

In some embodiments, the performing the at least one ML process operation further comprises selecting an ML model from among a plurality of trained ML models if the comparison of the obtained system information and acquired new SIB indicates that the ML model is valid for the serving mobile network cell.

In some embodiments, the performing the at least one ML process operation further comprises training a new ML model if the comparison of the obtained system information and acquired new SIB indicates that none of the plurality of trained ML models are valid for the serving mobile network cell.

In some embodiments, performing the at least one ML process operation further comprises executing one or more legacy procedures if the comparison of the obtained system information and acquired new SIB indicates that none of the plurality of trained ML models are valid for the serving mobile network cell.

In some embodiments, the network configuration assistance information is included in a network configuration assistance information SIB. In some embodiments, the obtaining the system information includes acquiring, in the serving mobile network cell, an new SIB and the network configuration assistance information associated with one or more of the plurality of cells in the mobile network. In some embodiments, the method further includes utilizing, in the serving mobile network cell, the obtained system information associated with the one or more of the plurality of cells in the mobile network to train the at least one ML model that is valid for the serving mobile network cell. In some embodiments, performing at least one ML process operation further comprises selecting an ML model via monitoring procedures, wherein the at least one ML model is valid for the plurality of cells.

In some embodiments, the method further comprises determining if a serving mobile network cell belongs to the plurality of cells in response to the UE entering into the serving mobile network cell. In some embodiments, the method further comprises selecting, in response to determining that the serving mobile network cell belongs to the plurality of cells, one or more of the at least one ML models that are valid for the plurality of cells.

In some embodiments, determining if a serving mobile network cell belongs to the plurality of cells further includes comparing new system information contained in the new SIB to the network configuration assistance information in the UE, and identifying the network configuration assistance information in the UE as being valid for the serving mobile network cell if the new system information contained in the new SIB matches the network configuration assistance information in the UE.

In some embodiments, the UE determines if the serving mobile network cell belongs to the plurality of cells by using an identifier part of a Channel State Information, CSI, resource or report configuration received by the UE. In some embodiments, the identifier part includes a beam pattern tag and/or a beam pattern configuration area identifier ID.

In some embodiments, the method further comprises further comprises storing network assistance related information contained in the new SIB along with corresponding network configuration assistance information for each of the plurality of cells. In some embodiments, the method further comprises selecting a ML model trained for a beam pattern configuration that is indicated by the stored network configuration assistance information identified as being valid for the serving mobile network cell, wherein the ML model is selected based on an associated identifier for the beam pattern configuration.

In some embodiments, the method further comprises conducting one or more remedial UE actions if the stored network configuration assistance information does not match the information contained in the new SIB. In some embodiments, wherein the remedial UE actions comprise requesting a fallback to a non-ML beam prediction algorithm, acquiring network configuration assistance information from the serving mobile network cell, and/or requesting a data collection for a current beam pattern configuration in the serving mobile network cell.

In some embodiments, entering in the serving mobile network cell comprises reconnecting to the serving mobile network cell. In some embodiments, the system information includes network assistance related information comprising a system information area identifier parameter, a value tag parameter, area scope parameter, and/or an expiration time parameter related to the network configuration assistance information. In some embodiments, the network assistance related information is contained in SI message acquisition information element, IE, data and/or SI-scheduling information IE data of the new SIB. In some embodiments, the network configuration assistance information SIB carries the network configuration assistance information that comprises network antenna and/or beam pattern related information and an expiration time parameter that indicates the validity of at least a portion of the network configuration assistance information.

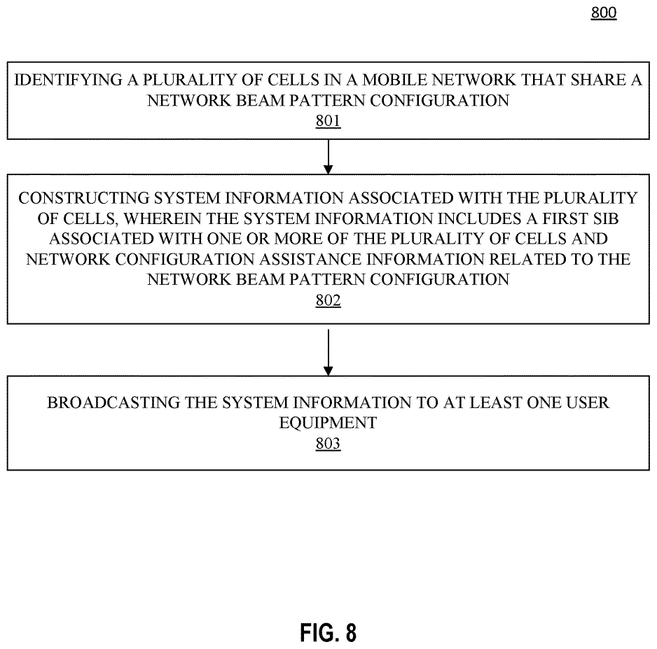

FIG. 8 illustrates a flowchart 800 of a method depicting exemplary operations for enabling efficient signaling of network configuration assistance information according to one embodiment. Operations of the network node, which may be implemented using the structure of the block diagram of FIG. 11, will now be discussed with reference to the flowchart 800 according to some embodiments. For example, one or more modules (e.g., software based algorithms or programming code) may be stored in memory 1104 of FIG. 11, and these modules may provide instructions so that when the instructions of a module are executed by respective processing circuitry 1102, the network node 1100 performs respective operations of the flowchart 800.

In block 801, the method 800 includes identifying a plurality of cells in a mobile network that share a network beam pattern configuration.

In block 802, the method 800 includes constructing system information associated with the plurality of cells, wherein the system information includes a first system information block, SIB, associated with one or more of the plurality of cells and network configuration assistance information related to the network beam pattern configuration.

In block 803, the method 800 includes broadcasting the system information to at least one user equipment.

In some embodiments, constructing system information comprises setting a common system information area identifier parameter in the first SIB.

In some embodiments, constructing system information comprises configuring the network beam pattern configuration information related to the network beam pattern configuration in network configuration assistance information. In some embodiments, constructing system information comprises setting a value tag parameter in the first SIB to indicate a version of the network beam pattern configuration. In some embodiments, constructing system information comprises setting an area scope parameter in the first SIB to indicate that the network configuration assistance information is area specific.

In some embodiments, the network configuration assistance information is contained in an associated network configuration assistance information SIB. In some embodiments, the network assistance related information comprises a system information area identifier parameter, a value tag parameter, area scope parameter, and/or an expiration time parameter related to the network configuration assistance information. In some embodiments, the network assistance related information is contained in SI message acquisition information element, IE, data and/or SI-scheduling information IE data of the first SIB.

In some embodiments, the network configuration assistance information SIB carries the network configuration assistance information comprising network antenna and/or beam pattern related information and an expiration time parameter that indicates the validity of at least a portion of the network configuration assistance information.

In some embodiments, the method further comprises setting an expiration time parameter for the network configuration assistance data that specifies a time duration indicative of the validity of content carried in the network configuration assistance data SIB.

In some embodiments, the network node is a gNB.

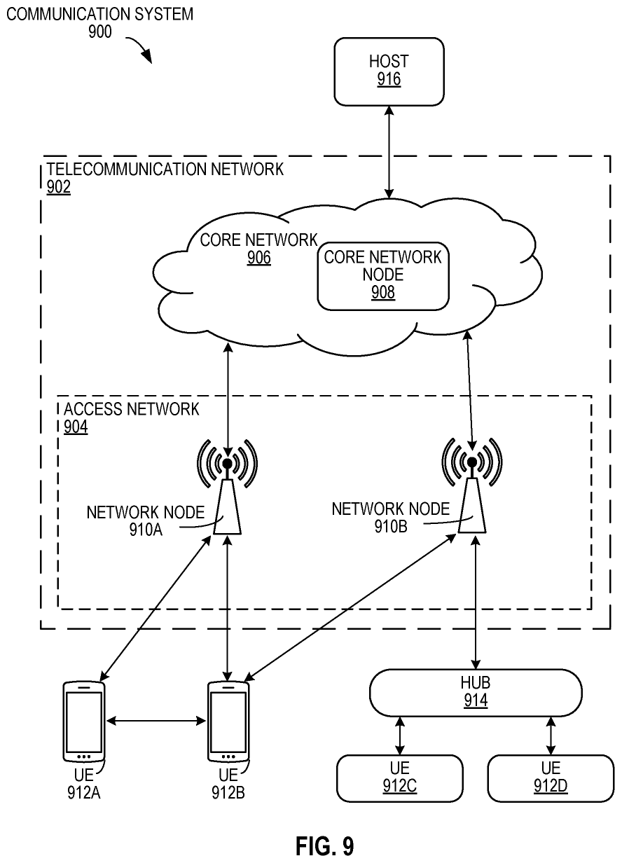

FIG. 9 shows an example of a communication system 900 in accordance with some embodiments. In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 902 includes one or more Open-RAN (ORAN) network nodes. An ORAN network node is a node in the telecommunication network 902 that supports an ORAN specification (e.g., a specification published by the O-RAN Alliance, or any similar organization) and may operate alone or together with other nodes to implement one or more functionalities of any node in the telecommunication network 902, including one or more network nodes 910 and/or core network nodes 908.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 1002.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1120 may include user interface equipment to allow input of information into the network node 1120 and to allow output of information from the network node 1120. This may allow a user to perform diagnostic, maintenance, repair, and other administrative functions for the network node 1120.

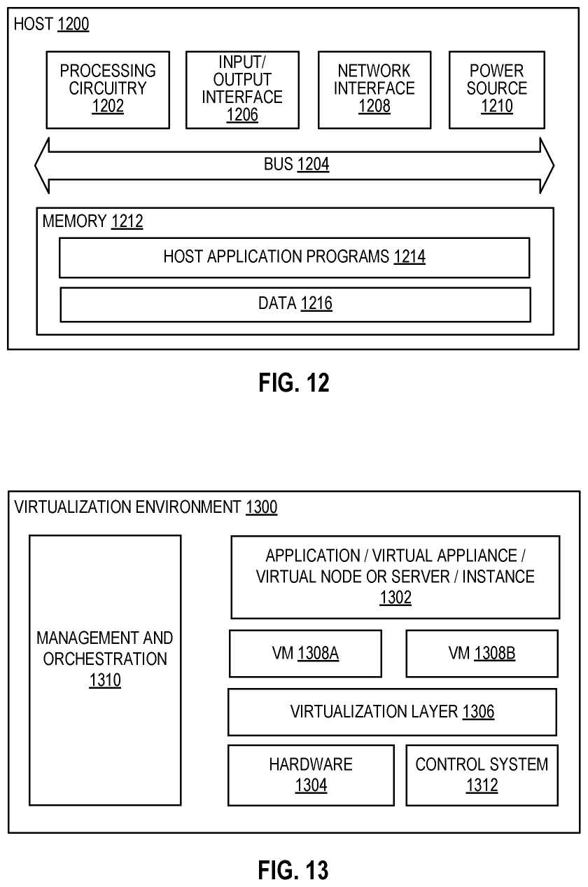

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1300 includes components defined by the O-RAN Alliance, such as an O-Cloud environment orchestrated by a Service Management and Orchestration Framework via an O-2 interface.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

A1. A method performed by a user equipment, UE, the method comprising:
acquiring (601) a first system information block 1, SIB1, and a corresponding networkAssistanceDataSIB associated with one or more cells in a mobile network;
storing (602) network configuration related assistance data contained in the first SIB1 along with the corresponding networkAssistanceDataSIB for each of the one or more cells;
entering (603) into a serving mobile network cell;
acquiring (604) a new SIB1 from the serving mobile network cell;
comparing (605) information contained in the new SIB1 to the stored network configuration related assistance data associated with each networkAssistanceDataSIB stored in the UE; and
identifying (606) a stored networkAssistanceDataSIB as being valid for the serving mobile network cell if the information contained in the new SIB1 matches the stored network configuration related assistance information associated with the stored networkAssistanceDataSIB.

A2. The method of embodiment A1 further comprising selecting an AI/ML model trained for a beam pattern configuration indicated by the stored networkAssistanceDataSIB identified as being valid.

A3. The method of any one of embodiments A1 to A2 further comprising conducting one or more remedial UE actions if the stored network configuration related assistance information does not match the information contained in the new SBI1.

A4. The method of any one of embodiments A1 to A3, wherein the remedial UE actions comprise requesting a fallback to a non-ML beam prediction algorithm, acquiring a networkAssistanceDataSIB from the serving mobile network cell, and/or requesting a data collection for a current beam pattern configuration in the serving mobile network cell.

A5. The method of any one of embodiments A1 to A4, wherein entering in the serving mobile network cell comprises reconnecting to the serving mobile network cell.

A6. The method of any one of embodiments A1 to A5, wherein the serving mobile network cell comprises a new mobile network cell.

A7. The method of any one of embodiments A1 to A6, wherein the network configuration related assistance information comprises a SystemInformationAreaID parameter, a valueTag parameter, areaScope parameter, and/or an expirationTime parameter related to the networkAssistanceDataSIB.

A8. The method of any one of embodiments A1 to A7, wherein the network configuration related assistance data contained in the first SIB1 along with the corresponding networkAssistanceDataSIB is stored in the UE.

A9. The method of any one of embodiments A1 to A8, wherein the network configuration related assistance data contained in the first SIB1 comprises SI message acquisition IE data and/or SI-schedulingInfo IE data.

A10. The method of any one of embodiments A1 to A9, wherein the networkAssistanceDataSIB carries network configuration assistance data that comprises network antenna and/or beam pattern related information and an expiration Time parameter that indicates the validity of at least a portion of the network configuration assistance data.

### Group B Embodiments

B1. A method performed by a network node, the method comprising:
identifying (501) mobile network cells that share a same beam pattern configuration;
setting (502) a common SystemInformation AreaID parameter in a networkAssistanceDataSIB message contained in a system information block 1, SIB1, associated with each of the identified mobile network cells;
configuring (503) beam pattern assistance information in the networkAssistanceDataSIB message in the SIB1;
setting (504) a valueTag parameter for the networkAssistanceDataSIB message in the SIB1 to indicate a version of the beam pattern configuration;
setting (505) an areaScope parameter for the networkAssistanceDataSIB message to indicate that the networkAssistanceDataSIB is area specific; and
broadcasting (506) the SIB containing the networkAssistanceDataSIB message and an associated networkAssistanceDataSIB.

B2. The method of embodiment B1, wherein the SIB1 is a Type 1 system information block.

B3. The method of any one of embodiments B1 to B2, wherein the networkAssistanceDataSIB message comprises SI message acquisition IE data and/or SI-schedulingInfo IE data.

B4. The method of any one of embodiments B1 to B3, further comprises setting an expiration Time parameter for the networkAssistanceDataSIB message that specifies a time duration indicative of the validity of content carried in the networkAssistanceDataSIB.

B5. The method of any one of embodiments B1 to B4, wherein the network node is a gNB.

B6. The method of any one of embodiments B1 to B4, wherein the network configuration related assistance information comprises network beam pattern configuration information.

### Group C Embodiments

C1. A user equipment comprising:
processing circuitry configured to perform any of the steps of any of the Group A embodiments; and
power supply circuitry configured to supply power to the processing circuitry.

C2. A network node comprising:
processing circuitry configured to perform any of the steps of any of the Group B embodiments;
power supply circuitry configured to supply power to the processing circuitry.

C3. A user equipment, UE, comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

1. A method performed by a user equipment, UE, operating in a mobile network, the method comprising:
obtaining system information associated with a plurality of cells of the mobile network, wherein the system information includes network configuration assistance information related to a network beam pattern configuration common to the plurality of cells;
acquiring a new system information block, SIB, when connecting to a serving mobile network cell in the mobile network; and
performing at least one machine learning, ML, process operation based on a comparison of the obtained system information and the acquired new SIB.

2. The method of claim 1, wherein performing the at least one ML process operation further comprises selecting an ML model from among a plurality of trained ML models if the comparison of the obtained system information and acquired new SIB indicates that the ML model is valid for the serving mobile network cell.

3. The method of claim 1, wherein performing the at least one ML process operation further comprises training a new ML model if the comparison of the obtained system information and acquired new SIB indicates that none of the plurality of trained ML models are valid for the serving mobile network cell.

4. The method of claim 1, wherein performing the at least one ML process operation further comprises executing one or more legacy procedures if the comparison of the obtained system information and acquired new SIB indicates that none of the plurality of trained ML models are valid for the serving mobile network cell.

5. The method of claim 1, wherein the network configuration assistance information is included in a network configuration assistance information SIB.

6. The method of claim 1, wherein obtaining the system information includes acquiring, in the serving mobile network cell, a first SIB and the network configuration assistance information associated with one or more of the plurality of cells in the mobile network.

7. The method of claim 1 further comprising utilizing, in the serving mobile network cell, the obtained system information associated with the one or more of the plurality of cells in the mobile network to train the at least one ML model that is valid for the serving mobile network cell.

8. The method of claim of claim 1, wherein performing at least one ML process operation further comprises selecting an ML model via monitoring procedures, wherein the at least one ML model is valid for the plurality of cells.

9-10. (canceled)

11. The method of claim 1, wherein determining if a serving mobile network cell belongs to the plurality of cells further includes:
comparing new system information contained in the new SIB to the network configuration assistance information in the UE; and
identifying the network configuration assistance information in the UE as being valid for the serving mobile network cell if the new system information contained in the new SIB matches the network configuration assistance information in the UE.

12. The method of claim 1, wherein a UE determines if the serving mobile network cell belongs to the plurality of cells by using an identifier part of a Channel State Information, CSI, resource or report configuration received by the UE.

13-21. (canceled)

22. A user equipment, UE, comprising:
processing circuitry; and
at least one memory storing instructions executable by the processing circuitry to perform operations to:
obtain system information associated with a plurality of cells of the mobile network, wherein the system information includes network configuration assistance information related to a network beam pattern configuration common to the plurality of cells;
acquire a first system information block, SIB, when connecting to a serving mobile network cell in the mobile network; and
perform at least one machine learning, ML, process operation based on a comparison of the obtained system information and the acquired new SIB.

23. The user equipment of claim 22, wherein performing the at least one ML process operation further comprises selecting an ML model from among a plurality of trained ML models if the comparison of the obtained system information and acquired new SIB indicates that the ML model is valid for the serving mobile network cell.

24. A method performed by a network node, the method comprising:
identifying a plurality of cells in a mobile network that share a network beam pattern configuration;
constructing system information associated with the plurality of cells, wherein the system information includes a first system information block, SIB, associated with one or more of the plurality of cells and network configuration assistance information related to the network beam pattern configuration; and
broadcasting the system information to at least one user equipment, UE.

25. The method of claim 24, wherein constructing system information comprises setting a common system information area identifier parameter in the first SIB.

26. The method of claim 24, wherein constructing system information comprises configuring the network beam pattern configuration information related to the network beam pattern configuration in network configuration assistance information.

27. The method of claim 24, wherein constructing system information comprises setting a value tag parameter in the first SIB to indicate a version of the network beam pattern configuration.

28. The method of claim 24, wherein constructing system information comprises setting an area scope parameter in the first SIB to indicate that the network configuration assistance information is area specific.

29. The method of claim 24, wherein the network configuration assistance information is contained in an associated network configuration assistance information SIB.

30-34. (canceled)

35. A network node comprising:
processing circuitry; and
at least one memory storing instructions executable by the processing circuitry to perform operations to:
identify a plurality of cells in a mobile network that share a network beam pattern configuration;
construct system information associated with the plurality of cells, wherein the system information includes a first system information block, SIB, associated with one or more of the plurality of cells and network configuration assistance information related to the network beam pattern configuration common to the plurality of cells; and
broadcast the system information to at least one user equipment, UE.

36. The network node of claim 35, wherein constructing system information comprises setting a common system information area identifier parameter in the first SIB.
